(19) United States
(12) Patent Application Publication
(10) Pub. No.: US 2015/0047575 A1
(43) Pub. Date: Feb. 19, 2015

(54) Pet Brush

(71) Applicant: LIN JUI-TSANG, Shenzhen (CN)

(72) Inventor: LIN JUI-TSANG, Shenzhen (CN)

(21) Appl. No.: 13/968,448

(22) Filed: Aug. 16, 2013

(51) Int. Cl. A01K 13/00

(52) U.S. Cl. CPC A01K 13/00
USPC 119/628

(57) ABSTRACT

A pet brush contains a brushing head including a concave face and a back face opposite to the concave face, wherein the brushing head connects with a support plate so as to form a receiving chamber in which a brushing member and a fixing member are mounted. The brushing member is disposed on the concave face, and the brushing head includes a first through hole, the brushing member further includes a second through hole, the fixing member includes at least one pressing strap for pressing the brushing member, and the support plate includes a connecting rod, the connecting rod has a first locking portion arranged on one end thereof, and the one end of the connecting rod inserts through the fixing member, the second through hole, and the first through hole to retain with a second locking portion of the plunger, thus connecting the plunger and the support plate together.

### FIELD OF THE INVENTION

The present invention relates to a pet brush.

### BACKGROUND OF THE INVENTION

A conventional pet brush attaches furs thereon easily, so a user has to remove furs manually. Another conventional pet brush is pressed to comb the pet' furs, but its bristles cannot be fixed on the pet brush, so after a period of using time, the bristles loosen easily. In addition, after the pressing member of the pet brush is pressed by a user, since the orifices of the pet brush are vertical, when the bristles move back to a support plate so that the user removes furs attaching on the bristles, the bristles cannot expose outsides the support plate, hence the bristles stick on the support plate. Also, as pressing the pressing member, the pressing member offsets easily without being fixed.

The present invention has arisen to mitigate and/or obviate the afore-described disadvantages.

### SUMMARY OF THE INVENTION

The primary object of the present invention is to provide a pet brush which is capable of overcoming the shortcomings of the conventional pet brush.

To obtain the above objective, a pet brush provided by the present invention contains: a brushing head, a support plate, and a movable plunger.

The brushing head includes a concave face defined on an inner surface thereof and a back face opposite to the concave face, wherein the brushing head connects with the support plate so as to form a receiving chamber in which a brushing member and a fixing member are mounted, the brushing member is disposed on the concave face, and the brushing head also includes a first through hole defined at a central position thereof, the brushing member further includes a second through hole defined at a central portion thereof, the fixing member includes at least one pressing strap for pressing the brushing member, and the support plate includes a connecting rod disposed thereon, the connecting rod has a first locking portion arranged on one end thereof, and the one end of the connecting rod inserts through the fixing member, the second through hole, and the first through hole to retain with a second locking portion of the plunger, thus connecting the plunger and the support plate together.

Thereby, the brushing member is disposed between the fixing member and the concave face, and the brushing head and the fixing member are fixed together by means of the at least one first retainer and the at least one second retainer, such that the brushing member is mounted on the concave face of the brushing head, and the at least one pressing strap of the fixing member presses the brushing member via the bristles, thus fixing the brushing member securely. Thereby, when the plunger moves, the brushing member does not loosen, thus fixing the pet brush securely.

Furthermore, the movable plunger is limited to vertically move in the anti-slip frame without offset. Because the cross section of each orifice contacting with the brushing member is formed in the Y shape, hence when the bristles pass through the orifices of the plurality of teeth, they moves smoothly without extending out of the plurality of teeth to be stuck.

### BRIEF DESCRIPTION OF THE DRAWINGS

FIG. 1 is a perspective view showing the exploded components of a pet brush according to a preferred embodiment of the present invention.

FIG. 2 is a perspective view showing the assembly of the pet brush according to the preferred embodiment of the present invention.

FIG. 3 is a perspective view showing the operation of the pet brush according to the preferred embodiment of the present invention.

FIG. 4 is a front plan view showing the assembly of a brushing head of the pet brush according to the preferred embodiment of the present invention.

FIG. 5 is a plan view showing the assembly of the pet brush according to the preferred embodiment of the present invention.

FIG. 6 is a perspective view showing the assembly of a brushing member of the pet brush according to the preferred embodiment of the present invention.

FIG. 7 is a perspective view showing the assembly of a support plate of the pet brush according to the preferred embodiment of the present invention.

FIG. 8 is a plan view showing the assembly of the support plate of the pet brush according to the preferred embodiment of the present invention.

FIG. 9 is a cross sectional taken along the line A-A of FIG. 8.

FIG. 10 is a perspective view showing the operation of the pet brush according to the preferred embodiment of the present invention.

FIG. 11 is a perspective view showing the operation of a plunger of the pet brush according to the preferred embodiment of the present invention.

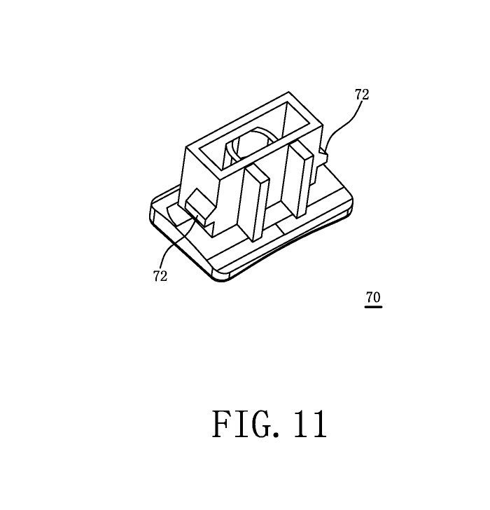

### DETAILED DESCRIPTION OF THE PREFERRED EMBODIMENTS

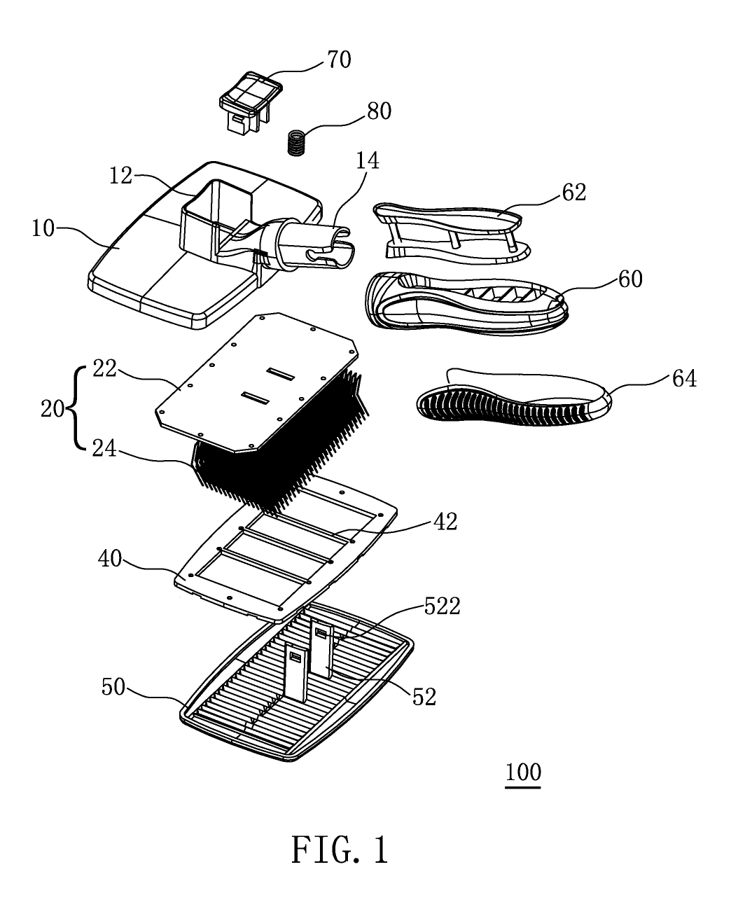

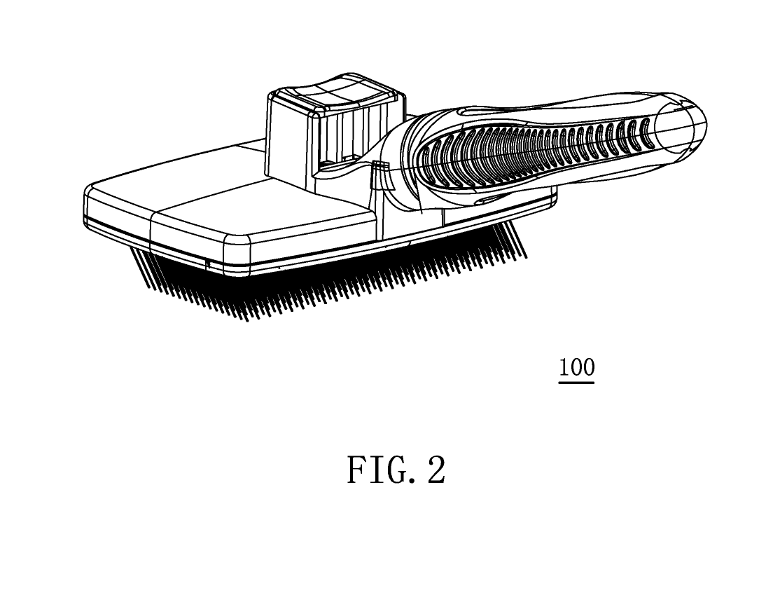

With reference to FIGS. 1 and 2, a pet brush 100 according to a preferred embodiment of the present invention comprises a brushing head 10, a support plate 50, and a movable plunger 70.

The brushing head 10 includes a concave face 15 defined on an inner surface thereof and a back face 17 opposite to the concave face 15, wherein the brushing head 10 connects with the support plate 50 so as to form a receiving chamber in which a brushing member 20 and a fixing member 40 are mounted, the brushing member 20 is disposed on the concave face 15, and the brushing head 10 also includes a first through hole 16 defined at a central position thereof, the brushing member 20 includes a second through hole 222 defined at a central portion thereof. The fixing member 40 includes at least one pressing strap 42 for pressing the brushing member 20, and the support plate 50 includes a connecting rod 52 disposed thereon, the connecting rod 52 has a first locking portion 52 arranged on one end thereof, and the one end of the connecting rod 50 inserts through the fixing member 40, the second through hole 222, and the first through hole 16 to retain with a second locking portion 72 of the plunger 70, thus connecting the plunger 70 and the support plate 50 together.

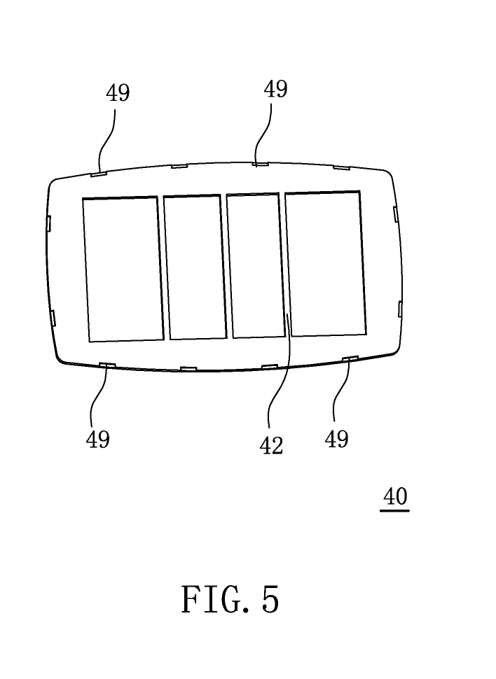

The at least one pressing strap 42 of the fixing member 40 presses the brushing member 20 via bristles 24 of the brushing member 20, such that the brushing member 20 is fixed on the concave face 15 of the brushing head 10 securely. When operating the pet brush, the brushing member 20 and the brushing head 10 connect together fixedly. In addition, a number of the at least one pressing strap is one, two, three, or more than three as shown in FIGS. 1 and 5.

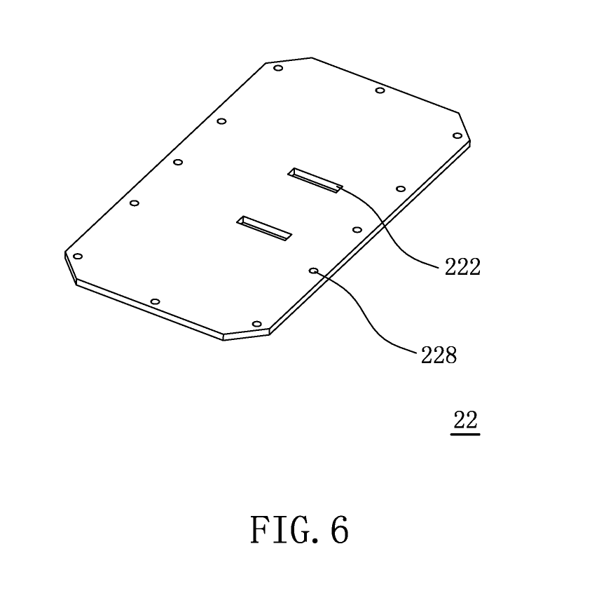

The brushing member 20 includes the bristles 24 and a positioning piece 22 made of rubber material (as shown in FIG. 6), and the bristles 24 are secured on the positioning piece 22.

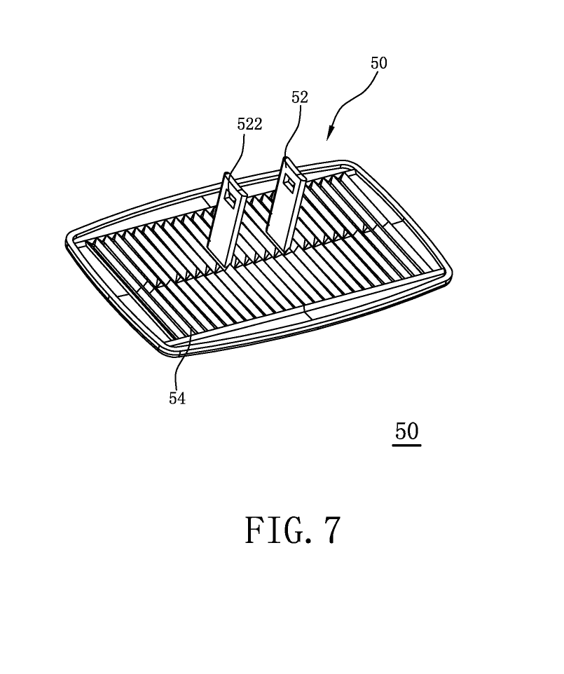

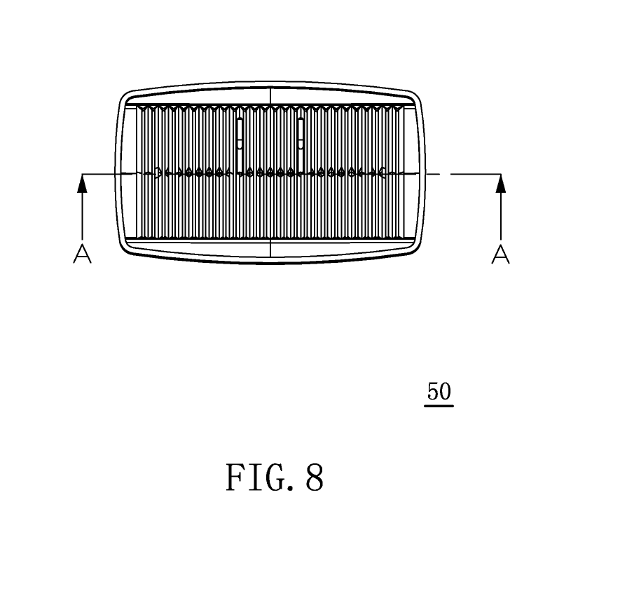

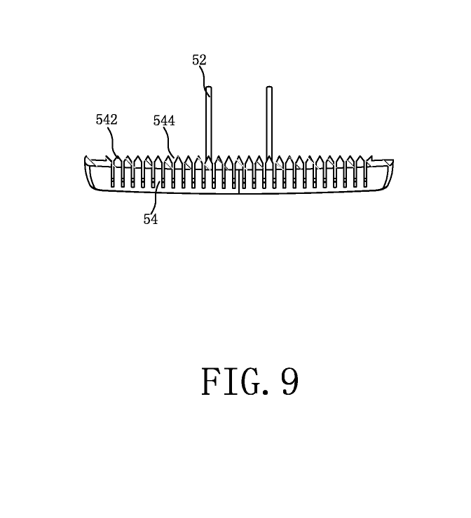

The support plate 50 includes a plurality of teeth 54, and between any two adjacent teeth 54 is defined an orifice 544 so that the bristles 24 extend out of the support plate 50 through orifices 544 of the plurality of teeth 54 as illustrated in FIGS. 7-9.

A cross section of an end 542 of each tooth 54 contacting with the bristles 24 is triangular or trapezoidal so that a cross section of one end of each orifice 544 contacting with the brushing member 20 is formed in a Y shape, hence when the movable plunger 70 is moved, the bristles 24 move in the orifices 544 of the support plate 50 smoothly without being stuck as illustrated in FIGS. 7-9.

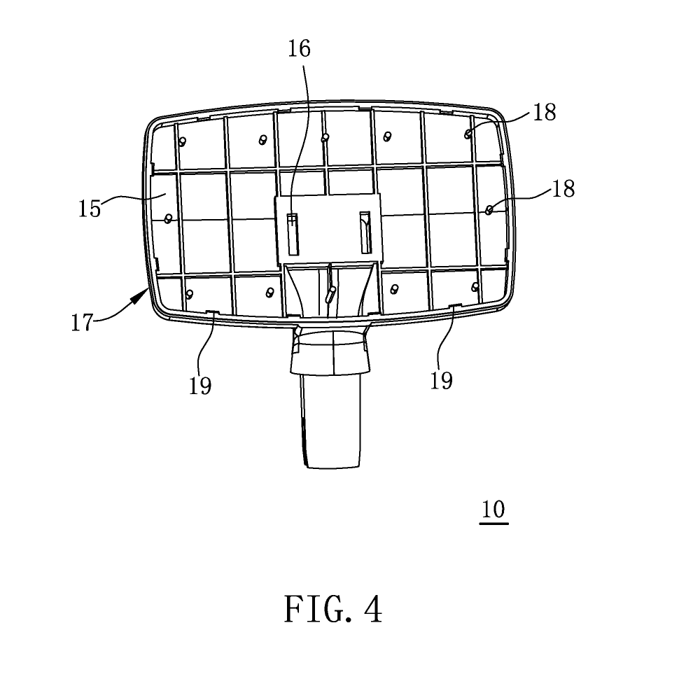

The brushing head 10 includes at least one first retainer 19 disposed around a peripheral side of the concave face 15, and the fixing member 40 includes at least one second retainer 49 mounted around a peripheral side thereof and retaining with the at least one first retainer 19, such that the brushing member 20 is fixed in the concave face 15 of the brushing head 10 as shown in FIGS. 4 and 5.

The brushing head 10 further includes a peg 13 secured on the back face 17 thereof and inserted into the first through hole 16, and between the peg 13 and the movable plunger 70 is defined a resilient element 80, wherein one end of the resilient element 80 abuts against the peg 13, and another end of the resilient element 80 is biased against the movable plunger 70, such that when the movable plunger 70 moves, the support plate 50 is driven by the movable plunger 70 to move relative to the bristles 24 and contacts with the brushing head 10 by ways of the resilient element 80.

Furthermore, the crushing head 10 includes an anti-slip frame 12 arranged on the back face 17 thereof, and the anti-slip frame 12 has an opening defined on one side thereof, wherein the first through hole 16 is defined in the anti-slip frame 12, and the anti-slip frame 12 covers the movable plunger 70 so that the movable plunger 70 contacts with an inner wall of the anti-slip frame 12 and is guided by the anti-slip frame 12, hence the movable plunger 70 moves vertically in the anti-slip frame 12 and prevents the support plate 70 from offset. It is to be noted that a height of the movable plunger 70 is not less than that of the anti-slip frame 12.

The brushing head 10 includes plural circular posts 18 fixed on the concave face 15, and the brushing member 20 includes a plurality of circular apertures 28 defined around an inner side thereof, since the brushing member 20 is mounted on the concave face 15 of the brushing head 10, the plural circular posts 18 insert through the plurality of circular apertures 28 as illustrated in FIG. 4.

Preferably, a moving travel of the plunger 70 is larger than a vertical length of each bristle 24, such that when the movable plunger 70 is pressed, the bristles 24 do not expose outsides the support plate 50, thus removing pet's furs effectively.

The brushing head 10 also includes a connector 14 coupled with the back face 17 and a handle 60. The handle 60 includes a mounting member 62 disposed therein and an engaging member 64 arranged thereon.

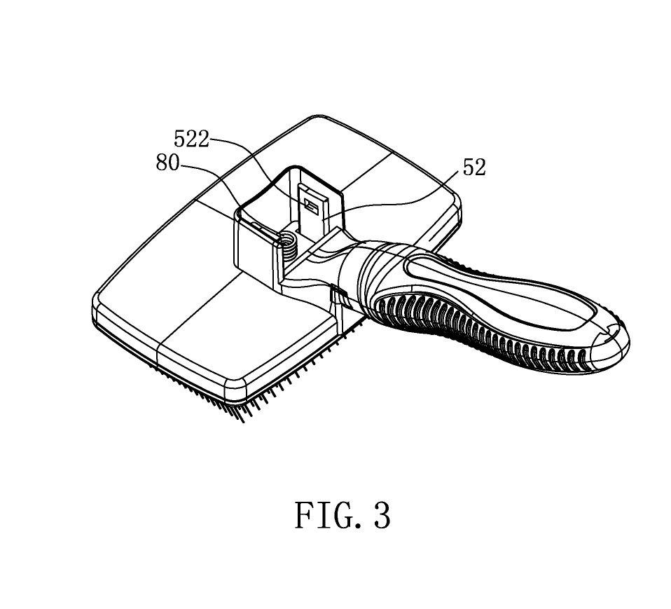

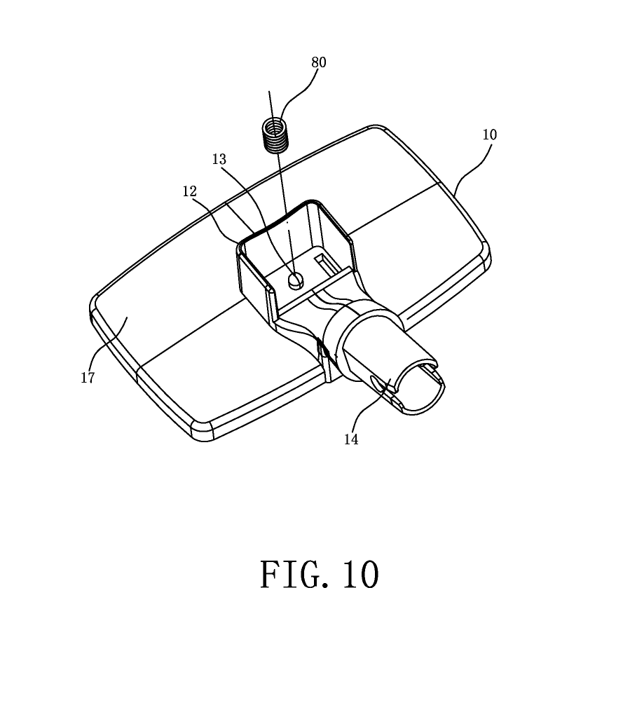

Preferably, the brushing member 20 is disposed between the fixing member 40 and the concave face 15, and the brushing head 10 and the fixing member 40 are fixed together by means of the at least one first retainer 19 and the at least one second retainer 49, such that the brushing member 20 is mounted on the concave face 15 of the brushing head 10, and the at least one pressing strap 42 of the fixing member 40 presses the brushing member 20 via the bristles 24, thus fixing the brushing member 20 securely. Thereby, when the plunger 70 moves, the brushing member 20 does not loosen, thus fixing the pet brush 100 securely, as shown in FIGS. 1, 3, and 10.

Furthermore, the movable plunger 70 is limited to vertically move in the anti-slip frame 12 without offset. Since the cross section of each orifice 544 contacting with the brushing member 20 is formed in the Y shape, hence when the bristles 24 pass through the orifices 544 of the plurality of teeth 54, they moves smoothly without extending out of the plurality of teeth 54 to be stuck as illustrated in FIGS. 1, 3, and 10.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A pet brush comprising:
a brushing head, a support plate, and a movable plunger, the brushing head including a concave face defined on an inner surface thereof and a back face opposite to the concave face, wherein the brushing head connects with the support plate so as to form a receiving chamber in which a brushing member and a fixing member are mounted, the brushing member is disposed on the concave face, and the brushing head also includes a first through hole defined at a central position thereof, the brushing member further includes a second through hole defined at a central portion thereof, the fixing member includes at least one pressing strap for pressing the brushing member, and the support plate includes a connecting rod disposed thereon, the connecting rod has a first locking portion arranged on one end thereof, and the one end of the connecting rod inserts through the fixing member, the second through hole, and the first through hole to retain with a second locking portion of the plunger, thus connecting the plunger and the support plate together.

2. The pet brush as claimed in claim 1, wherein a number of the at least one pressing strap is any one of one, two and three.

3. The pet brush as claimed in claim 1, wherein the brushing member includes the bristles and a positioning piece, and the bristles are secured on the positioning piece.

4. The pet brush as claimed in claim 3, wherein the support plate includes a plurality of teeth, and between any two adjacent teeth is defined an orifice so that the bristles extend out of the support plate through orifices of the plurality of teeth.

5. The pet brush as claimed in claim 4, wherein a cross section of an end of each tooth contacting with the bristles is triangular or trapezoidal so that a cross section of one end of each orifice contacting with the brushing member is formed in a Y shape.

6. The pet brush as claimed in claim 1, wherein the brushing head includes at least one first retainer disposed around a peripheral side of the concave face, and the fixing member includes at least one second retainer mounted around a peripheral side thereof and retaining with the at least one first retainer.

7. The pet brush as claimed in claim 1, wherein the brushing head further includes a peg secured on the back face thereof and inserted into the first through hole, and between the peg and the movable plunger is defined a resilient element, wherein one end of the resilient element abuts against the peg, and another end of the resilient element is biased against the movable plunger.

8. The pet brush as claimed in claim 1, wherein the crushing head includes an anti-slip frame arranged on the back face thereof, and the anti-slip frame has an opening defined on one side thereof, wherein the first through hole is defined in the anti-slip frame, and the anti-slip frame covers the movable plunger, wherein a height of the movable plunger is not less than that of the anti-slip frame.

9. The pet brush as claimed in claim 1, wherein the brushing head includes plural circular posts fixed on the concave face, and the brushing member includes a plurality of circular apertures defined around an inner side thereof, such that the brushing member is mounted on the concave face of the brushing head, the plural circular posts insert through the plurality of circular apertures.

10. The pet brush as claimed in claim 1, wherein a moving travel of the plunger is larger than a vertical length of each bristle.
